(19) United States
(12) Patent Application Publication
(10) Pub. No.: US 2021/0311320 A1
(43) Pub. Date: Oct. 7, 2021

(54) VIRTUAL REALITY TRACKING SYSTEM

(71) Applicant: PIKE ENTERPRISES, LLC, Mount Airy, NC (US)

(72) Inventors: J. Eric Pike, Lewisville, NC (US); Amarnath Reddy Vangoor, Lewisville, NC (US)

(73) Assignee: PIKE ENTERPRISES, LLC, Mount Airy, NC (US)

(21) Appl. No.: 17/223,460

(22) Filed: Apr. 6, 2021

Related U.S. Application Data
(60) Provisional application No. 63/005,700, filed on Apr. 6, 2020.

(51) Int. Cl. G02B 27/01; G06T 15/20; G02B 27/00; G06T 7/73; G06F 1/16

(52) U.S. Cl. CPC G02B 27/0176; G06T 15/20; G02B 2027/0138; G06T 7/73; G06F 1/1694; G02B 27/0093

(57) ABSTRACT

A virtual reality system may comprise a head-mounted display comprising: a sensor for tracking an object, the sensor having a first field-of-view; an auxiliary sensor system coupled to the head-mounted display and having a second field-of-view, wherein the first field-of-view and the second field-of-view overlap to form a combined field-of-view. The head-mounted display may be configured to track a position of the object with the sensor; render the object in the virtual environment based on the position determined by the sensor; determine that the object has left the first field-of-view of the sensor and entered the second field-of-view associated with the auxiliary sensor system; in response to determining that the object has left the first field-of-view and entered the second field-of-view, track the position of the object with the auxiliary sensor system; and render the object in the virtual environment based on the position determined by the auxiliary sensor system.

### CROSS-REFERENCE TO RELATED APPLICATION

This application claims the benefit of U.S. Provisional Application No. 63/005,700 filed Apr. 6, 2020, which is hereby incorporated by reference herein in its entirety.

### FIELD OF THE INVENTION

The present invention relates to virtual reality devices and, more specifically, to systems and methods for positional tracking of objects relative to an all-in-one, virtual reality head-mounted device.

### BACKGROUND

Virtual reality (VR) systems and devices are able to provide computer-rendered simulations and artificial representations of three-dimensional environments for human virtual interaction. In particular, the ability to simulate even hazardous environments or experiences in a safe environment provides an invaluable tool for modern training techniques by giving personnel in hazardous occupational fields (e.g., electrical line work, construction, and the like) the opportunity to acquire simulated, hands-on experience. That said, limitations in VR hardware and software, such as accurate environmental and/or object tracking, can hinder a user experience by interrupting a user's natural interactive process which, ultimately, adversely affects user immersion. As a result, there exists a need for an improved virtual reality system to address these issues.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In a first aspect, embodiments of the present invention relate to a virtual reality system that includes: a head-mounted display configured for rendering and displaying a virtual environment. The head-mounted display may include: at least one sensor for tracking an object in a surrounding environment, the at least one sensor having a first field-of-view; an auxiliary sensor system coupled to the head-mounted display, the auxiliary sensor system having a second field-of-view, where the first field-of-view and the second field-of-view overlap to form a combined field-of-view, and where the combined field-of-view is greater than the first field-of-view; a processing device; a memory device; and computer-readable instructions stored in the memory. The computer-readable instructions, when executed by the processing device, may cause the processing device to: track a position of the object in the surrounding environment with the at least one sensor; render the object in the virtual environment based on the position determined by the at least one sensor; determine that the object has left the first field-of-view of the at least one sensor and entered the second field-of-view associated with the auxiliary sensor system; in response to determining that the object has left the first field-of-view and entered the second field-of-view, track the position of the object in the surrounding environment with the auxiliary sensor system; and render the object in the virtual environment based on the position determined by the auxiliary sensor system.

In some embodiments, either alone or in combination with other embodiments of the first aspect, the combined field-of-view is at least 340°.

In some embodiments, either alone or in combination with other embodiments of the first aspect, the first field-of-view is 200° or less.

In some embodiments, either alone or in combination with other embodiments of the first aspect, the virtual reality system further includes a user input device, where the object tracked by the at least one sensor and the auxiliary sensor system is the user input device.

In some embodiments, either alone or in combination with other embodiments of the first aspect, tracking the positioning of the object in the surrounding environment with the auxiliary sensor system further includes translating from a first coordinate system associated with the auxiliary sensor system to a second coordinate system associated with the head-mounted display.

In a second aspect, embodiments of the present invention relate to a computer program product for improving a virtual reality system, the computer program product including at least one non-transitory computer-readable medium having computer-readable instructions embodied therein. The computer-readable instructions, when executed by a processing device, may cause the processing device to perform the steps of: tracking a position of an object in a surrounding environment with at least one sensor of a head-mounted display; rendering the object in a virtual environment based on the position determined by the at least one sensor; determining that the object has left a first field-of-view of the at least one sensor and entered a second field-of-view associated with an auxiliary sensor system coupled to the head-mounted display; in response to determining that the object has left the first field-of-view and entered the second field-of-view, track the position of the object in the surrounding environment with the auxiliary sensor system; and render the object in the virtual environment based on the position determined by the auxiliary sensor system.

In some embodiments, either alone or in combination with other embodiments of the second aspect, the object tracked by the at least one sensor and the auxiliary sensor system is a user input device.

In some embodiments, either alone or in combination with other embodiments of the second aspect, tracking the positioning of the object in the surrounding environment with the auxiliary sensor system further comprises translating from a first coordinate system associated with the auxiliary sensor system to a second coordinate system associated with the head-mounted display.

In a third aspect, embodiments of the present invention relate to a virtual reality system that includes: a user input device comprising an orientation sensor configured for collecting orientation data associated with the user input device; and a head-mounted display in communication with the user input device, the head-mounted display being configured for rendering and displaying a virtual environment. The head-mounted display may further include: a sensor for tracking a position of the user input device, the at least one sensor having a field-of-view; a processing device; a memory device; and computer-readable instructions stored in the memory. The computer-readable instructions, when executed by the processing device, may cause the processing device to: track the position of the user input device with the sensor; render an object in the virtual environment based on the position of the user input device determined by the sensor; determine that the user input device has left the field-of-view of the sensor; in response to determining that the user input device has left the field-of-view of the sensor, determine a new position of the user input device based on the orientation data collected from the orientation sensor; and render the object in the virtual environment based on the new position.

In some embodiments, either alone or in combination with other embodiments of the third aspect, determining the new position of the user input device based on the orientation data further includes transforming the orientation data to translational position data. Transforming the orientation data to translational position data may further comprise deriving a rotational offset from the orientation data of the user input device.

In some embodiments, either alone or in combination with other embodiments of the third aspect, determining the new position of the user input device further comprises determining a last known position of the user input device with the sensor before the user input device leaves the field-of-view, and wherein the new position is based at least partially on the last known position.

In some embodiments, either alone or in combination with other embodiments of the third aspect, the orientation sensor is selected from a group consisting of an inertial measurement unit, an accelerometer, a gyroscope, and a motion sensor.

In a fourth aspect, embodiments of the present invention relate to a computer program product for improving a virtual reality system, the computer program product including at least one non-transitory computer-readable medium having computer-readable instructions embodied therein. The computer-readable instructions, when executed by a processing device, may cause the processing device to perform the steps of: tracking a position of a user input device using a sensor of a head-mounted display, wherein the user input device comprises an orientation sensor; rendering an object in a virtual environment based on the position of the user input device determined by the sensor; determining that the user input device has left a field-of-view of the sensor; in response to determining that the user input device has left the field-of-view of the sensor, determining a new position of the user input device based on orientation data collected from the orientation sensor; and rendering the object in the virtual environment based on the new position.

In some embodiments, either alone or in combination with other embodiments of the fourth aspect, determining that the user input device has left a field-of-view of the sensor further comprises transforming the orientation data to translational position data. Transforming the orientation data to translational position data may further comprise deriving a rotational offset from the orientation data of the user input device.

In some embodiments, either alone or in combination with other embodiments of the fourth aspect, determining the new position of the user input device further comprises determining a last known position of the user input device with the sensor before the user input device leaves the field-of-view, and wherein the new position is based at least partially on the last known position.

In some embodiments, either alone or in combination with other embodiments of the fourth aspect, the orientation sensor is selected from a group consisting of an inertial measurement unit, an accelerometer, a gyroscope, and a motion sensor.

### BRIEF DESCRIPTION OF THE DRAWINGS

Having thus described embodiments of the invention in general terms, reference will now be made to the accompanying drawings, wherein:

FIG. 1 provides user operation of a virtual reality simulation system, in accordance with one embodiment of the invention;

FIG. 2 provides a block diagram of a virtual reality simulation system, in accordance with one embodiment of the invention;

FIG. 3 provides a block diagram of a modified virtual reality simulation system, in accordance with one embodiment of the invention;

FIG. 4 illustrates a modified head-mounted display for a virtual reality simulation system, in accordance with one embodiment of the invention;

FIG. 5 illustrates a modified head-mounted display for a virtual reality simulation system, in accordance with one embodiment of the invention;

FIG. 6 provides a high level process flow for integration of additional sensor data from auxiliary sensors into a head-mounted display, in accordance with one embodiment of the invention;

FIG. 7 provides a high level process flow for calculating controller positioning data based on controller orientation data, in accordance with one embodiment of the invention;

FIG. 8A provides a screenshot of a determined controller displacement calculation, in accordance with one embodiment of the invention; and

FIG. 8B provides a screenshot of a determined controller displacement calculation, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

As used herein the term “virtual reality” may refer to a computer-rendered simulation or an artificial representation of a three-dimensional image or environment that can be interacted with in a seemingly real or physical way by a person using special electronic equipment or devices, such as the devices described herein. In a specific example, a virtual environment may be rendered that simulates a hazardous working environment or hazardous materials and/or equipment (e.g., electric line work, construction, or the like).

Virtual reality environments are typically designed or generated to present particular experiences (e.g., training programs) to users. Typically, a VR environment is designed on a computing device (e.g., a desktop computer) and populated with various additional scenery and objects (e.g., tools and equipment) in order to simulate an actual environment in the virtual reality space. In an experience such as a training program, generating the VR environment may further include defining interactions between objects within the environment and/or allowed interactions between objects and the user. For example, one or more buttons, levers, handles, grips, or other manipulatable objects or interfaces may be configured within a VR environment to enable user interaction with said objects to complete tasks or other objectives required by an experience. The user typically manipulates the objects via the controllers or other user input devices which, in some embodiments, represent the user's hands.

Virtual reality training and evaluation systems provide an innovative tool for the safe instruction and assessment of users working in various fields, particularly in hazardous occupational fields such as construction, electrical line work, and the like. The systems typically render a virtual environment and prompt the user to perform a task related to their occupation in the virtual environment. In exemplary embodiments, the task is an electrical, gas, or water construction, maintenance, or service task. By way of a particular example, such task may be a particular type of activity performed in the field of line work, and the virtual environment may simulate a physical line working environment. Performance of the task typically involves completion of a number of subtasks. To complete the task (including related subtasks), the user typically interacts with the virtual environment via a head-mounted display and one or more handheld motion tracking input controllers.

These systems typically monitor the user's actions in real-time within the virtual environment while the user is completing the assigned task and related subtasks. As such, accurate tracking of the user and the user's actions within the virtual environment is pivotal. An evaluation system compares the user's actions to defined criteria to quantify and evaluate the safety, step-process accuracy, and efficiency of the completed tasks by the user. Monitoring the user's interactions within the virtual environment allows for in-depth scoring and analysis to provide a comprehensive view of a user's performance that can be used to identify specific skills or gaps in knowledge that may require improvement or additional training. For example, a user's overall evaluation score may be broken down into individual steps or time intervals that may be individually assessed. Furthermore, more-important subtasks or actions may be given higher score weighting than less-important subtasks in order to emphasize the importance or the potentially hazardous nature of certain subtasks. Scores may be generated in real-time during a training simulation and provided to a user upon completion based on the user's actions.

In a specific example, these systems may be utilized to perform a training simulation related to an electrical, gas, or water construction, maintenance, or service task, such as replacement of a transformer bank. The user may select the transformer bank replacement training experience within the virtual environment and then perform a series of subtasks (e.g., actions) that relate to complete of this task (i.e., transformer bank replacement). The user's interactions with the virtual environment are received via user input devices and progress is monitored recorded by the evaluation system and compared to scoring criteria related to proper execution of the task and subtasks. The user completes the experience by either completing the task associated with the experience (i.e., replacement of the transformer bank) or executing a critical error (e.g., touching an uninsulated conductor) that triggers failure. Due to the dependence of the VR training program on the accuracy of the VR hardware, accurate tracking of the user and user interactions with a virtual environment is key. That said, due to the limitations of conventional VR hardware (e.g., limited sensor fields-of-view), natural user movements and interactions may not be accurate tracked, thereby hindering user immersion and realistic simulation of real-world tasks. In a specific example particular to the electrical line working field, proper operation of a lift bucket requires that a user operate a control lever while facing a direction of bucket movement which is typically in a direction facing away from the controls. Conventional VR systems having limited sensor fields-of-view encounter difficulty accurately tracking the user hand and/or controller movements positioned behind the user.

As used herein, the term “user” may refer to any individual or entity (e.g., a business) associated with the virtual reality system and/or devices described herein. In one embodiment, a user may refer to an operator or wearer of a virtual reality device that is interacting with a virtual environment. In a specific embodiment, a user is performing a training and evaluation exercise via the virtual reality device. In some embodiments, a user may refer to an individual or entity associated with another device operably coupled to the virtual reality device or system. For example, the user may be a computing device user, a phone user, a mobile device application user, a training instructor, a system operator, a support technician, an employee of an entity or the like. In some embodiments, identities of an individual may include online handles, usernames, identification numbers, aliases, or the like. A user may be required to authenticate an identity of the user by providing authentication information or credentials (e.g., a password) in order to interact with the systems described herein (i.e., log on).

As used herein the term “computing device” may refer to any device that employs a processor and memory and can perform computing functions, such as a personal computer, a mobile device, an Internet accessing device, or the like. In one embodiment, a computing device may include a virtual reality device such as a device comprising a head-mounted display and one or more additional user input devices (e.g., controllers).

As used herein, the term “computing resource” may refer to elements of one or more computing devices, networks, or the like available to be used in the execution of tasks or processes such as rendering a virtual reality environment and executing a virtual reality simulation. A computing resource may include processor, memory, network bandwidth and/or power used for the execution of tasks or processes. A computing resource may be used to refer to available processing, memory, and/or network bandwidth and/or power of an individual computing device as well as a plurality of computing devices that may operate as a collective for the execution of one or more tasks. For example, in one embodiment, a virtual reality device may include dedicated computing resources (e.g., a secondary or on-board processor) for rendering a virtual environment or supplementing the computing resources of another computing device used to render the virtual environment.

Virtual reality (VR) systems and devices are able to provide computer-rendered simulations and artificial representations of three-dimensional environments for human virtual interaction. In recent years, development of such technology has focused on reducing the number of hardware components required to operate a VR setup. As such, inside-out VR tracking, which eliminates the need for separate, external tracking cameras or sensors, has become increasingly popular with hardware developers for reducing a required VR device and accessory footprint. Although all-in-one (AIO) head-mounted displays (HMDs) have been previously developed, existing systems typically include a significant disadvantage: a limited field-of-view for tracking a surrounding environment, and more importantly, input devices (i.e., controllers) controlled by a user. Conventional AIO VR systems typically include an HMD having a combination of only one or more forward and/or side-facing cameras or sensors for tracking the user's hands and handheld input devices. As such, a common issue for preexisting AIO systems is the cameras or sensors mounted on with the HMD losing a clear line-of-sight with an input device when the input device is obscured by another object or the user (e.g., behind the user's back). As a result, there exists a need for an improved inside-out, VR tracking system to address this issue.

Embodiments of the present invention are directed to a virtual reality (VR) system, and specifically, an all-in-one, head-mounted VR device utilizing innovative inside-out environmental object tracking and positioning technology. As previously discussed, the invention seeks to provide a solution for conventional HMDs losing a clear line-of-sight with an input device when the input device is obscured by another object or the user (e.g., behind the user's back) while retaining the portability of the AIO device.

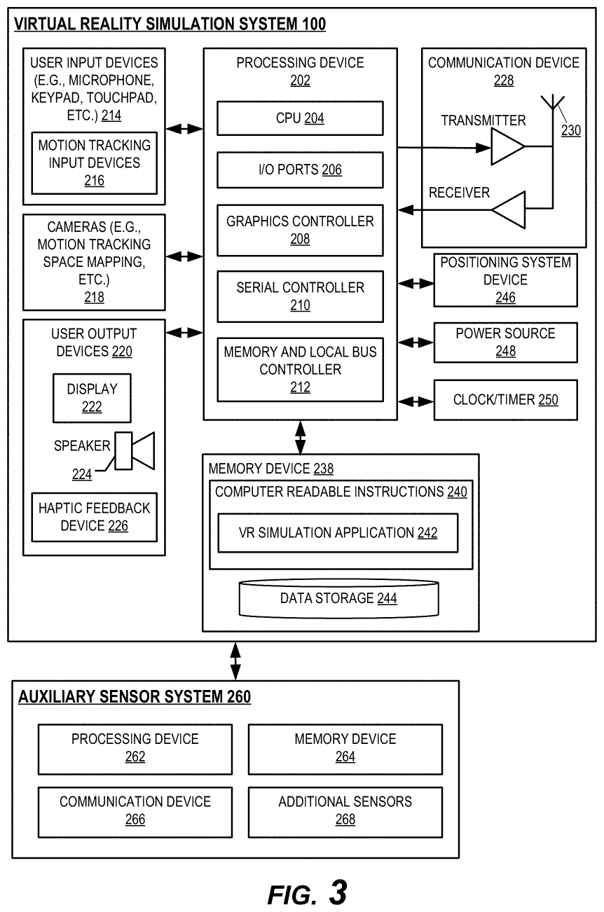

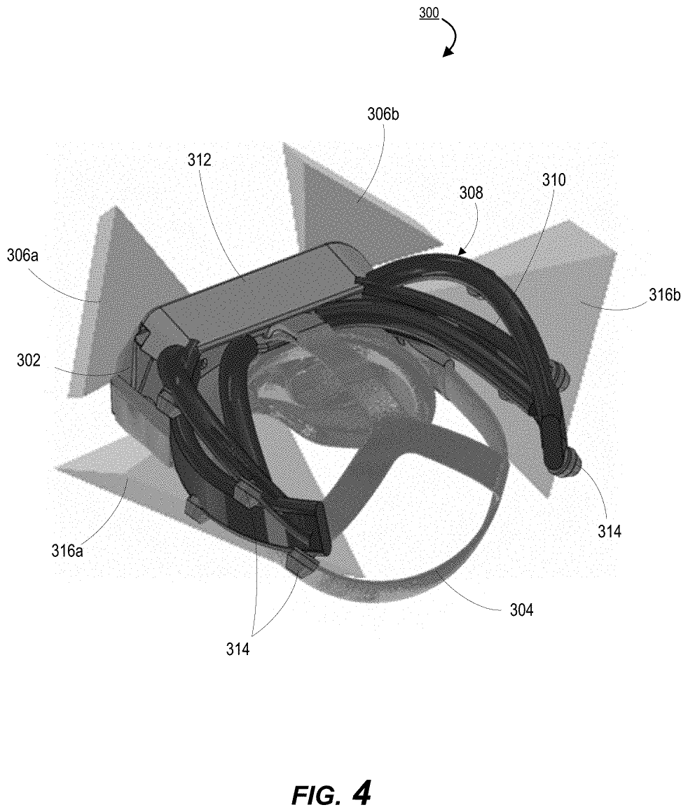

In one aspect of the invention, a hardware-based solution is provided to improve user input device (i.e., controller) tracking. As illustrated and discussed with respect to FIGS. 3 and 4, in this solution, an array of additional of sensors are incorporated into a traditional AIO VR device, wherein the additional sensors are positioned on a head-mounted device rearward of a display portion proximate a head support or strap. The additional sensors are configured to expand the field-of-view of the preexisting HMD cameras or sensors by providing a near-360° view around the user for tracking user-operated controllers or other input devices. As the additional sensors are coupled directly to the HMD without additional wires, the invention is able to improve environmental tracking while preserving the wireless portability and form-factor of the AIO VR headset. Positioning or tracking data determined by the additional sensors is integrated into the HMD, wherein a software development kit component calibrates the received tracking data with a tracking offset value to make data compatible with HMD's preexisting coordinate system. Additionally, tracking data from the HMD sensors and the additional sensors is validated through sampling of captured frames output by the display portion of the HMD. In this way, errors such as bugs and edge cases can be identified and corrected.

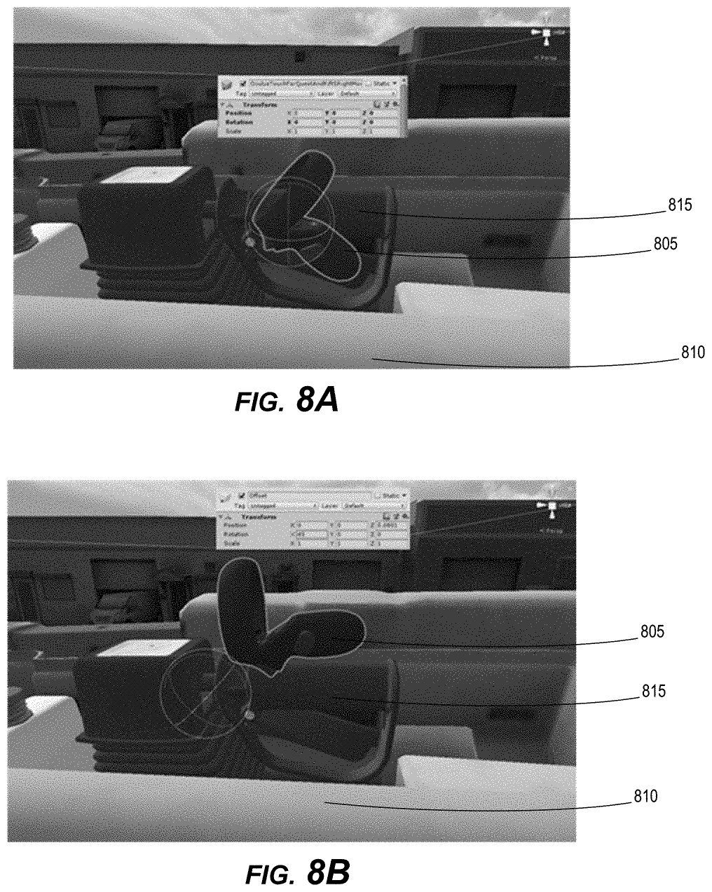

In another aspect of the invention, the systems and methods described herein provide an alternative, purely software-based solution for improving tracking of the user input devices (i.e., controllers). The controllers of the VR systems comprise motion sensors, such as an inertial measurement unit (IMU), and are configured to determine orientation data for the controllers even when the controllers are out of view of the HMD's cameras or sensors (e.g., behind a user's back). Although the orientation data can provide an orientation of the controller itself, a position of the controller relative to the HMD is not typically able to be provided by this data alone. That said, the present invention is configured to model and/or calculate translational positioning data for the controllers by adding a rotational offset value to the orientation data determined by the controllers. In this way, translational positioning data for the controllers can be derived even if the controllers are out of view of the HMD cameras or sensors (FIGS. 8A and 8B). What is more, by leveraging transformation of the collected orientation data instead of relying on additional camera hardware, this software-based solution is not dependent on a camera field-of-view and can provide an improved, effective field-of-view for positional tracking of the controllers around the user in some embodiments.

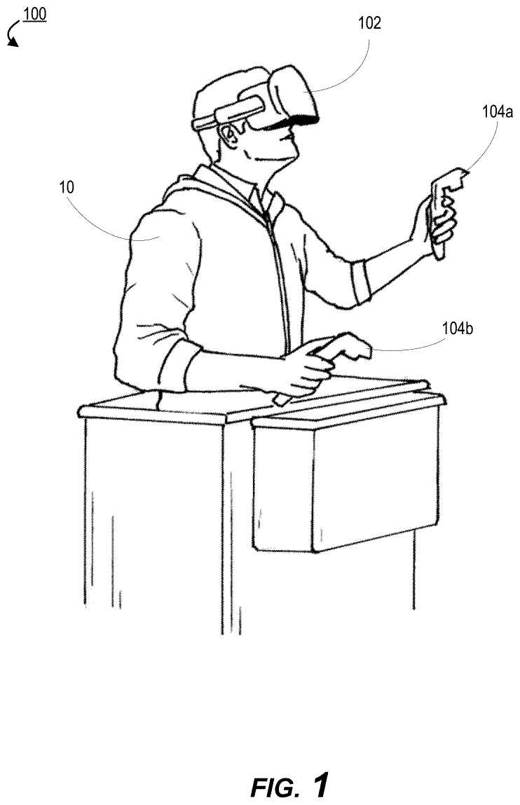

FIG. 1 illustrates user operation of a virtual reality simulation system 100, in accordance with one embodiment of the invention. The virtual reality simulation system 100 typically renders and/or displays a virtual environment for the user 10 and provides an interface for the user 10 to interact with the rendered environment. As illustrated in FIG. 1, the virtual reality simulation system 100 may include a head-mounted display (HMD) virtual reality device 102 worn on the head of a user 10 interacting with a virtual environment. In a preferred embodiment, the virtual reality simulation system 100 is an all-in-one HMD virtual reality device, wherein all processing and rendering of a virtual reality simulation is executed entirely on the computer hardware of the HMD virtual reality device without an additional computing device. Examples of all-in-one HMD devices include an Oculus Quest™ virtual reality system, an HTC Vive Focus™ virtual reality system, or other similar all-in-one virtual reality systems. Alternatively, a modified VR headset incorporating an additional sensor array is illustrated and discussed in great detail with respect to FIGS. 3-5 below.

The VR simulation system 100 may further include first 104a and a second 104b motion tracking input devices embodied as handheld controllers held by the user 10. As previously discussed, the first 104a and second 104b motion tracking input devices are typically configured to receive the user's 10 actual movements and position in an actual space and translate the movements and position into a simulated virtual reality environment. In one embodiment, the first 104a and second 104b controllers track movement and position of the user 10 (e.g., the user's hands) over six degrees of freedom in three-dimensional space. The controllers 104a, 104b may further include additional input interfaces (i.e., buttons, triggers, touch pads, and the like) on the controllers 104a, 104b allowing for further interface with the user 10 and interaction with the virtual environment. In some embodiments, the HMD 102 and/or controllers 104a, 104b further comprises a camera, sensor, accelerometer or the like for tracking motion and position of the user's 10 head in order to translate the motion and position within the virtual environment.

Generally, the HMD 102 is positioned on the user's head and face, and the system 100 is configured to present a VR environment to the user. Controllers 104a and 104b may be depicted within a virtual environment as a virtual representations of the user's hands, wherein the user may move and provide input to the controllers 104a, 104b to interact with the virtual environment.

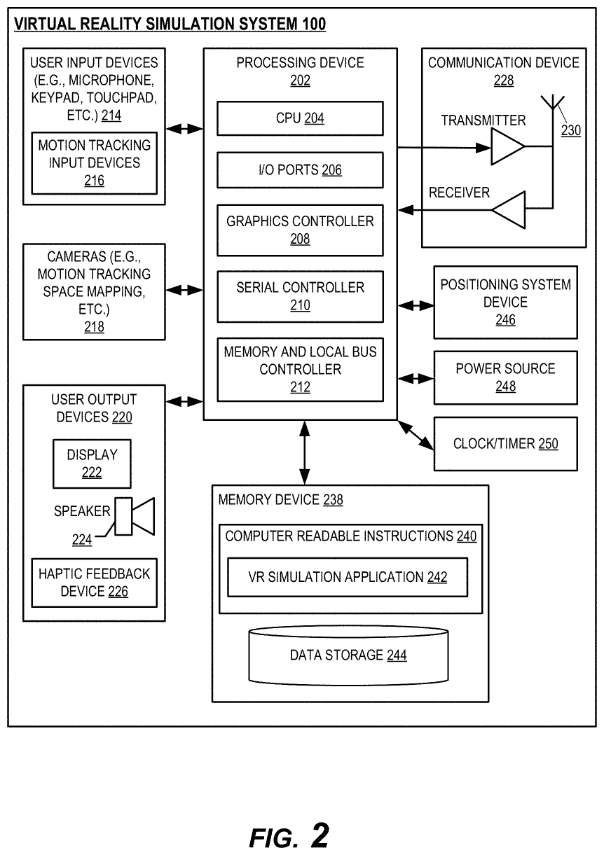

FIG. 2 provides a block diagram of the VR simulation system 100, in accordance with one embodiment of the invention. The VR simulation system 100 generally includes a processing device or processor 202 communicably coupled to devices such as, a memory device 238, user output devices 220, user input devices 214, a communication device or network interface device 228, a power source 248, a clock or other timer 250, a visual capture device or other sensor such as a camera 218, a positioning system device 246. The processing device 202 may further include a central processing unit 204, input/output (I/O) port controllers 206, a graphics controller or GPU 208, a serial bus controller 210 and a memory and local bus controller 212.

The processing device 202 may be configured to use the communication device 228 to communicate with one or more other devices over a network. Accordingly, the communication device 228 may include a network communication interface. The VR simulation system 100 may also be configured to operate in accordance with Bluetooth® or other communication/data networks via a wireless transmission device 230 (e.g., in order to communicate with user input devices 214 and user output devices 220).

The processing device 202 may further include functionality to operate one or more software programs or applications, which may be stored in the memory device 238. The VR simulation system 100 comprises computer-readable instructions 240 and data storage 244 stored in the memory device 238, which in one embodiment includes the computer-readable instructions 240 of a VR simulation application 242. In some embodiments, the VR simulation application 242 provides one or more virtual reality environments, objects, training programs, evaluation courses, or the like to be executed by the VR simulation system 100 to present to the user 10. The VR simulation system 100 may further include a memory buffer, cache memory or temporary memory device operatively coupled to the processing device 202. Typically, one or more applications (e.g., VR simulation application 242), are loaded into the temporary memory during use. As used herein, memory may include any computer readable medium configured to store data, code, or other information. The memory device 238 may include volatile memory, such as volatile Random Access Memory (RAM) including a cache area for the temporary storage of data. The memory device 238 may also include non-volatile memory, which can be embedded and/or may be removable. The non-volatile memory may additionally or alternatively include an electrically erasable programmable read-only memory (EEPROM), flash memory or the like.

The user input devices 214 and the user output devices 220 allow for interaction between the user 10 and the VR simulation system 100. The user input devices 214 provide an interface to the user 10 for interacting with the VR simulation system 100 and specifically a virtual environment displayed or rendered by the VR simulation system 100. As illustrated in FIG. 2, the user input devices 214 may include a microphone, keypad, touchpad, touch screen, and the like. In one embodiment, the user input devices 214 include one or more motion tracking input devices 216 used to track movement and position of the user 10 within a space. The motion tracking input devices 216 may include one or more handheld controllers or devices (e.g., wands, gloves, apparel, and the like) that, upon interaction with the user 10, translate the user's 10 actual movements and position into the simulated virtual reality environment. In specific examples, movement, orientation, and/or positioning of the user 10 within an actual space can be captured using accelerometers, a geo-positioning system (GPS), inertial measurement units, or the like. Furthermore, an actual space and motion tracking of the user 10 and/or objects within the actual space can be captured using motion tracking cameras or the like which may be configured to map the dimensions and contents of the actual space in order to simulate the virtual environment relative to the actual space.

The user output devices 220 allow for the user 10 to receive feedback from the virtual reality simulation system 100. As illustrated in FIG. 2, the user output devices include a user display device 222, a speaker 224, and a haptic feedback device 226. In one embodiment, haptic feedback devices 226 may be integrated into the motion tracking input devices 216 (e.g., controllers) in order to provide a tactile response to the user 10 while the user 10 is manipulating the virtual environment with the input devices 216.

The user display device 222 may include one or more displays used to present to the user 10 a rendered virtual environment or simulation. In a specific embodiment, the user display device 222 is a head-mounted display (HMD) comprising one or more display screens (i.e., monocular or binocular) used to project images to the user to simulate a 3D environment or objects. In an alternative embodiment, the user display device 222 is not head-mounted and may be embodied as one or more displays or monitors with which the user 10 observes and interacts. In some embodiments, the user output devices 220 may include both a head-mounted display (HMD) that can be worn by a first user and a monitor that can be concurrently viewed by a second user (e.g., an individual monitoring the first user's interactions with a virtual environment).

In some embodiments, the system comprises a modified virtual reality simulation system incorporating additional hardware to supplement the cameras, sensors, and/or processing capabilities of a conventional VR headset such as the headset of FIG. 2. A modified virtual reality simulation system is illustrated in the block diagram of FIG. 3. The modified virtual reality simulation system of FIG. 3 generally comprises the virtual reality simulation system 100 as previously discussed with respect to FIG. 2 as well as a supplemental hardware portion, auxiliary sensor system 260. Auxiliary sensor system 260 is configured to be in communication with the virtual reality simulation system 100 via wired or wireless communication channels to enable the transmission of data and/or commands between the merged or connected devices.

As illustrated in FIG. 3, the auxiliary sensor system generally comprises a processing device 262, a memory device 264, a communication device 266, and additional sensors 268. In some embodiments, the processing device 262, memory device 264, and communication device 266 are substantially the same as those components described with respect to the virtual reality simulation system 100. It should be understood that, in some embodiments, the auxiliary sensor system 260 comprises a separate processing device 262 and other components and functionalities separate from those of the VR simulation system 100. In some embodiments, the processing device 262 of the auxiliary sensor system 260 is an auxiliary controller, wherein the auxiliary sensor system 260 may be configured to perform independent routines and calculations from that of the VR simulation system 100 to supplement and increase the processing efficiency of a modified VR simulation system as a whole. It should be understood that one or more of the steps described herein may be performed by either the VR simulation system 100, the auxiliary sensor system 260, or a combination of the systems described herein. In some embodiments, a process may be performed by one system and transmitted to another system for further analysis and processing. In a specific embodiment, the auxiliary sensor system 260 may be configured to collect data via additional sensors 268 and transmit said data to the VR simulation system 100 for further use.

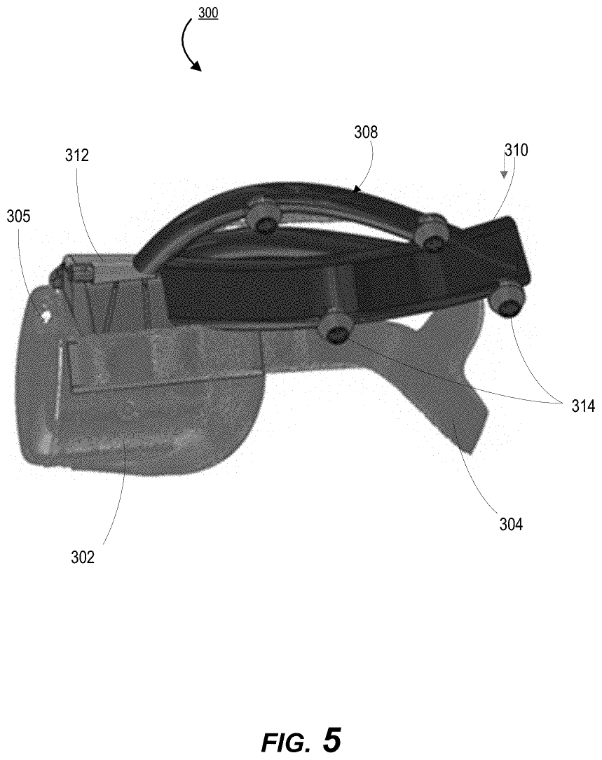

As discussed above, the modified VR simulation system of FIG. 3 includes an auxiliary sensor system 260 having additional sensors 268. FIGS. 4 and 5 illustrate a modified head-mounted display for a virtual reality simulation system, in accordance with one embodiment of the invention. In some embodiments the modified headset 300 of FIGS. 4 and 5 is the modified VR simulation system of FIG. 3 (i.e., a modified version of the headset described with respect to FIGS. 1 and 2). The modified headset 300 comprises an HMD 302 which further includes a support band or strap 304 for securing the HMD 302. The HMD 302 depicted in FIGS. 4 and 5 further comprises at least two standard cameras or sensors 305 positioned on a front and/or side of the headset 300. These cameras or sensors 305 are configured to track a position of an environment and/or user input devices such as controllers held and manipulated by a user. As illustrated by projections 306a, 306b in FIG. 4, the cameras or sensors 305 provide a limited field-of-view of about 180° for positional tracking around the headset 300 and the user. In another embodiment, the cameras or sensors 305 have a field-of-view of no more than 200°. As such, if a controller or other tracked object were to leave the field-of-view represented by these projections 306a, 306b, the headset 300 would not be able to track the position of the controller with the cameras or sensors 305 alone.

To remedy this deficiency of the standard cameras or sensors 305, the illustrated headset 300 further comprises an array of additional sensors 308 configured to extend the field-of-view of the headset 300 to a near-360° coverage or field-of-view. As illustrated in FIG. 4, the array 308 may comprise a cage-like frame 310 configured to support one or more additional sensors 314. Non-limiting examples of the one or more additional sensors include cameras, motion sensors, infrared sensors, proximity sensors, and the like.

As seen from the illustrated projections 316a, 316b, the additional sensors 314, when used with the standard cameras or sensors 305, provide a wider field of view than with the standard sensors of the HMD 302 alone. In one embodiment, a combined field-of-view of the standard sensors 305 when supplemented by the additional sensors 314 is at least 300°. In another embodiment, the combined field-of-view of the sensors 305,314 is at least 350°. In yet another embodiment, the sensors 305, 314 have a combined field-of-view of near-360°.

In the illustrated embodiment, at least some of the additional sensors 314 are angled at least partially downward to provide a better viewing area for tracking controllers or other input devices held by a user wearing the modified headset 300. The frame 310 and the additional sensors 314 are operatively coupled to the HMD 302 via a connection base 312 which plugs directly into the HMD 302. Through this direct connection, the sensors 314 of the array 308 are able to communicate with the HMD 302 to provide additional positional tracking information for tracking objects in the surrounding environment.

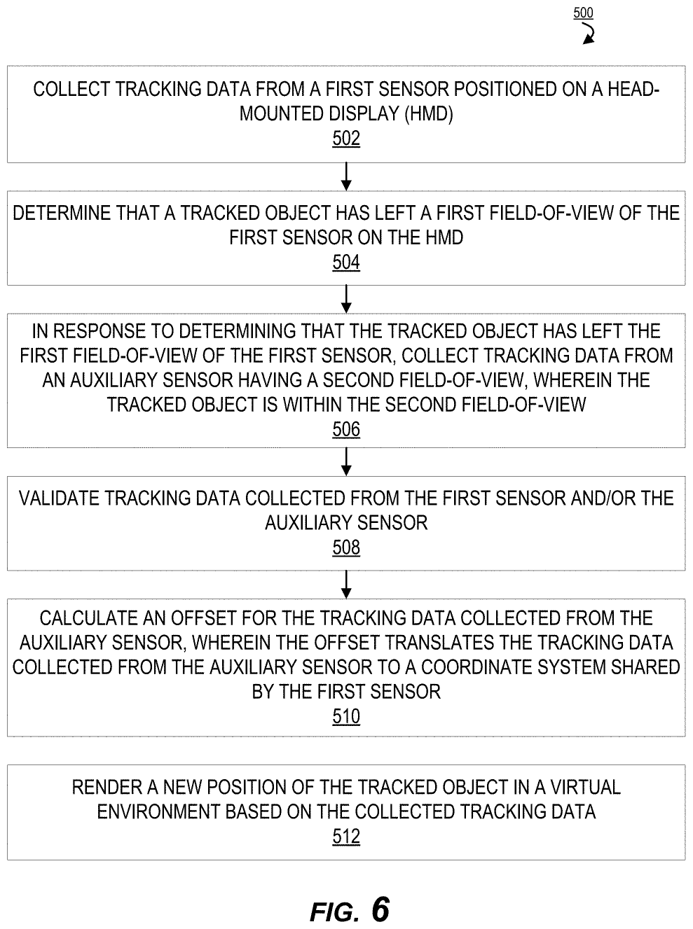

In some embodiments, the array of additional sensors 308 is a supplemental or auxiliary sensor system, such as the auxiliary sensor system 260 depicted in FIG. 3, which may be integrated into a preexisting head-mounted display such as HMD 302. FIG. 6 provides a high level process flow 500 for integration of additional sensor data from auxiliary sensors into a head-mounted display, in accordance with one embodiment of the invention. As illustrated in block 502, a VR system, such as a headset, is configured to collect tracking data from a first sensor positioned on a head-mounted display. The first sensor has an associated field-of-view, wherein a trackable object may be visibly tracked by the first sensor (e.g., projections 306a, 306b of FIG. 4). In some embodiments, the first sensor is a plurality of sensors positioned on an HMD. For example, in one embodiment, the first sensor includes one or more front and/or side-facing cameras positioned on the HMD. In some embodiments, a VR system may further comprise an auxiliary sensor system comprising one or more additional sensors such as the modified headset 300 of FIG. 4. The auxiliary sensor system may have a second field-of-view that overlaps with and/or extends beyond the first field-of-view of the first sensor.

The sensors of the VR system (e.g., the first sensor on the HMD) are configured to track a position of one or more trackable objects in an environment surrounding the HMD and subsequently generate tracking data related to a position of the tracked object. In a specific embodiment, the tracked object comprises one or more controllers and/or hands of a user or wearer of an HMD and VR system, wherein tracking or positioning data is collected for each of the one or more controllers for processing by the VR system. In one embodiment, tracking data associated with a position of a trackable object is collected by the sensors for every frame generated by an HMD of a VR system. In some embodiments, collected tracking data is stored (e.g., in an array) by the system for sampling and additional processing (e.g., a buffer).

As illustrated in block 504, the system is configured to determine that a tracked object has left a first field-of-view associated with the first sensor positioned on the HMD. In one embodiment, the system determines that a trackable object has left a field-of-view when the object passes beyond a boundary of an area defining the field-of-view. In another embodiment, the system determines that a trackable object has left a field-of-view when a line-of-sight between a sensor associated with the field-of-view and the trackable object is broken or obstructed, wherein the sensor is no longer able to track the object. For example, another object may become positioned between the tracked object and the sensor to obstruct the line-of-sight. In another example, the tracked object may become positioned behind a portion of a user during normal operation of the VR system.

As illustrated in block 506, in response to determining that the tracked object has left the first field-of-view of the first sensor, the VR system collects tracking data from an auxiliary sensor having a second field-of-view, wherein the tracked object is within the second field-of-view. In some embodiments, the system is further configured to determine that a tracked object has entered a second field-of-view as the tracked object leaves the first field-of-view. For example, in one embodiment, a tracked object, such as a controller, may leave a first field-of-view associated with a first sensor positioned on an HMD and enter a second field-of-view associated with an auxiliary sensor. In this embodiment, the VR system is configured to continuously and seamlessly track a position of the tracked object with the sensors as the tracked object travels between different fields-of-view.

In one embodiment, the VR system is configured to trigger collection of tracking data of a trackable object in the second field-of-view when the system determines that the trackable object has left the first field-of-view. For example, the VR system may determine that a tracked object (e.g., a controller held in a user's hand) has left a first field-of-view associated with a first sensor of an HMD, and accordingly begin to collect data using an auxiliary sensor having a second field-of-view. In another embodiment, the VR system is configured to continuously collect tracking data in both the first field-of-view and the second field-of-view, wherein only collected tracking data from a field-of-view associated with an observed trackable object is used by the system to generate a displayed output of a VR environment to a user via the HMD.

As illustrated in block 508, the system is configurated to validate the tracking data collected from the first sensor and/or the auxiliary sensor. Tracking data from the HMD sensors and the auxiliary sensors is validated through sampling of captured frames output by the display portion of the HMD, wherein collected data is compared to a stored buffer. In this way, errors such as bugs and edge cases can be identified and corrected. In one embodiment, the system may be configured to determine an error based on comparison of collected tracking data to a stored buffer. In some embodiments, the buffer may comprise a determined range of acceptable values for which newly collected tracking data is compared to determine potential errors, wherein the buffer data is based on previously collected and stored tracking data. In a particular example, a large delta or shift of position determined between the stored buffer data and the collected HMD sensor data may be indicative of a potential error. In one embodiment, when presented with data from both the HMD sensors and the auxiliary sensors, the system may be configured to default to depending on the auxiliary sensors if no errors are detected in the tracking data collected from the auxiliary sensor system.

As illustrated in block 510, the system is configured to calculate an offset for the tracking data collected from the auxiliary sensor, wherein the offset translates the tracking data collected from the auxiliary sensor to a coordinate system shared by the first sensor. The tracking offset may occur due to the combination of the two different hardware system of the HMD and the auxiliary sensor systems. In some embodiments, positioning data collected from the auxiliary sensor system may be required to be transformed or translated to a common coordinate system in order to be accurately used by the HMD receiving the additional data. In this way, the offset present between the HMD and the auxiliary sensor system is determined and applied as a correction factor to allow for merging of the tracking data collected from both systems.

In one example, the positioning data from the auxiliary sensor system is translated from a first coordinate system associated with the auxiliary sensor system to a second coordinate system associated with the HMD. In some embodiments, this transformation of the data may be performed using an algorithm or other calculation on the auxiliary sensory system hardware itself before being communicated to the HMD. In other embodiments, the HMD is configured to receive the raw positioning data from the auxiliary sensor system and translate the positioning data to a native coordinate system. An algorithm or other calculations are used to transform the data through, for example, application of a calculated offset or correction factor. In one embodiment, the system is configured to calculate a static offset to translate the positioning data to the native coordinate system. In another embodiment, the system is configured to continually recalculate a dynamic offset value as positioning data is received from the auxiliary sensor system. In one embodiment, calculation of an offset value between different coordinate system may be based on tracking data collected by both systems within a region of overlapping field-of-views, wherein positional data for a same point may be collected and compared from both systems.

At block 512, the system is configured to render a new position of the tracked object in a virtual environment based on the collected tracking data. The tracked object is rendered by the system and displayed to a user via a display of the HMD, wherein the new position of the tracked object corresponds to an actual position of the tracked object relative to the user in the actual environment. The collected tracking data used by the system to render the tracked object in the new position may include tracking data collected from the sensors of the HMD and/or the tracking data collected from the auxiliary sensor system. In one embodiment, the tracking data may include data collected from the auxiliary sensor system and translated to a coordinate system native to the HMD, wherein an offset is applied to the auxiliary sensor data to make it compatible.

Through incorporation of the auxiliary sensor system and integration of the additional tracking data collected over a wider available total field-of-view, the present invention improves the overall object-tracking capability of conventional VR systems, and specifically, AIO HMD devices having primarily front and/or side-facing camera tracking systems. In additional to the supplemental hardware of the auxiliary sensor system, the present invention further leverages a software component for calculating and applying an offset to the tracking data collected with the auxiliary sensors to allow for integration within the preexisting HMD device.

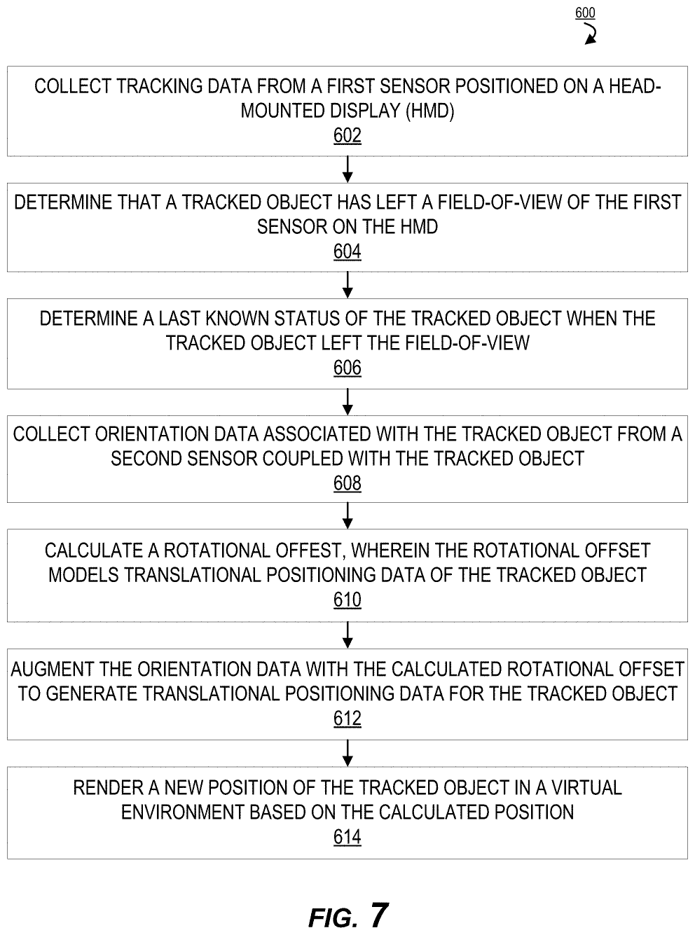

In alternative embodiments, the present invention further provides a software-based solution utilizing existing hardware in a non-conventional way to improve tracking of the user input devices (i.e., controllers). FIG. 7 provides a high level process flow 600 for calculating controller positioning data based on controller orientation data, in accordance with one embodiment of the invention. As illustrated in block 602, a VR system, such as a headset, is configured to collect tracking data from a first sensor positioned on a head-mounted display. As previously discussed, in some embodiments, the first sensor has an associated field-of-view, wherein a trackable object may be visibly tracked by the first sensor. In some embodiments, the first sensor is a plurality of sensors positioned on an HMD. For example, in one embodiment, the first sensor includes one or more front and/or side-facing cameras positioned on the HMD. The sensors of the VR system are configured to track a position of one or more trackable objects in an environment surrounding the HMD and subsequently generate tracking data related to a position of the tracked object. In a specific embodiment, the tracked object comprises one or more controllers and/or hands of a user or wearer of an HMD and VR system, wherein tracking or positioning data is collected for each of the one or more controllers for processing by the VR system.

As illustrated in block 604, the system is configured to determine that a tracked object has left a field-of-view of the first sensor on the HMD. In one embodiment, the system determines that a trackable object has left a field-of-view when the object passes beyond a boundary of an area defining the field-of-view. In another embodiment, the system determines that a trackable object has left a field-of-view when a line-of-sight between a sensor associated with the field-of-view and the trackable object is broken or obstructed, wherein the sensor is no longer able to track the object. For example, another object may become positioned between the tracked object and the sensor to obstruct the line-of-sight. In another example, the tracked object may become positioned behind a portion of a user during normal operation of the VR system.

As illustrated in block 606, the system is configured to determine a last known status of the tracked object when the tracked object left the field-of-view of the first sensor. In some embodiments, a status of a tracked object may comprise a location, a position, an angle, positioning data, a speed and/or acceleration of movement, a magnitude of a movement of the object, or the like. In one embodiment, the first sensor associated with the HMD may determine a last known status of a tracked object as the tracked object leaves the field-of-view of the first sensor. In another embodiment, wherein the tracked object is a controller, a sensor of the controller may determine a last known status of the controller as the controller leaves a field-of-view of a first sensor on the HMD. In yet another embodiment, a last known status may be determined by both the first sensor on the HMD and another sensor associated with the controller, wherein the output of the various sensors is used to agree upon a last know status. For example, an output of the controller sensor may be used to confirm a last known status determined by the sensor of the HMD. In some embodiments, a last known status of a tracked object is used to, at least in part, determine or predict a current positional status of the tracked object. In some embodiments, the system may be configured to utilize a last known position of the tracked object as a default starting point for determining a calculated position if the tracked object is lost or an error in accurately tracking the object is encountered.

In a specific embodiment, the system is configured to collect and generate a sample of frame data using the first sensor of the HMD while the tracked object (e.g., a controller) is in view of HMD. In one example, the system checks every frame (e.g., at 72 Hz) to determine a position of the controller relative to the HMD, i.e., a last known position of the controller should the controller leave the field-of-view of the first sensor of the HMD. As discussed further below, this sampling data may be used by the system to calculate a rotational offset value to calculate positioning data (i.e., translational data) of a tracked object when the tracked object is no longer in view of the first sensor of the HMD, wherein only orientation data (i.e., rotational data) collected from one or more additional sensors associated with the tracked object is used to simulate translational movement of the tracked object (e.g., controller).

As illustrated in block 608, the VR system is configured to collect orientation data associated with the tracked object from a second sensor coupled with the tracked object. As previously discussed, the tracked object may comprise one or more user input devices or, more specifically, one or more controllers. The controllers of the VR systems further comprise additional sensors such as a motion sensor, an inertial measurement unit (IMU), an accelerometer, a gyroscope, or other sensors. In some embodiments, the controller sensors are typically configured to determine orientation data (i.e., rotational data) for the controllers even when the controllers are out of view of the HMD's cameras or sensors (e.g., behind a user's back).

The orientation data typically comprises an angular position of a tracked object with respect to a baseline such as an established horizontal plane. Changes in an angular position of the tracked object can be tracked about an established axis of rotation of the tracked object (e.g., x, y, z axes in a 3D space associated pitch, roll, and yaw rotations). For example, at time t₁, the tracked object may have a first angular position about an axis of rotation relative to a horizontal plane of θ₁. Following a rotation of the tracked object about the axis of rotation, the tracked object may then be determined to have a second angular position θ₂ at time t₂. In some embodiments, the system tracks and measures a rotation of the tracked object using a system of angles about three axes (e.g., x, y, z) such as Euler angles which describe the overall rotation in combination. In other embodiments, the system may be configured or customized for a specific action within the virtual environment (e.g., operation of a bucket handle), wherein movement relative to the coordinate system is tuned or customized to the specific action. For example, in the specific embodiment of operating a bucket handle, the system may limit the range of motion and axis of rotation so that the tracked range of motion is limited to two axes of rotation (e.g., an x,y plane wherein rotation about the two axes (i.e., pitch and roll) is specifically tracked). In this way, calculations and simulation of movements may be simplified and a margin for error for the specific action may be reduced. Furthermore, the limited range of motion may accurately simulate an actual movement of the specified action. For example, the handle of lift bucket may actually only be moveable in an x,y plane in a real-world environment.

Although the orientation data collected from the controllers can provide data related to an orientation of the controller itself (i.e., an angular position), translational position or a translational change in position of the controller relative to the HMD is not typically able to be provided by this data alone. That said, the system is configured to simulate or calculate a translational displacement of the tracked object when it is out of view of the first sensors of the HMD using the measured changes in angular position determined by the additional sensors of the tracked object (e.g., FIGS. 8A and 8B). In context of the previously discussed example of simulated operation of a lift bucket handle, although the system is able to track the pitch and roll about the defined axes, without further processing and manipulation of the data, the system can not yet determine the translation of the tracked object (i.e., the controller used to interact with the handle).

As illustrated in block 610, the system is configured to calculate a rotational offset, wherein the rotational offset is used to model or simulate translational positioning data for the tracked object. The rotational offset may be calculated when the tracked object is in the view of the HMD sensors. In one embodiment, the rotational offset is a displacement or offset of the controller or tracked object from a point of rotation about one or more axes. This offset data combined with the determined change in orientation or rotational data may be used by the system to simulate a translation or resulting position of the tracked object as a result of a measured rotation even when the tracked object is out of view of the HMD sensors.

In one embodiment, the system is configured to continually collect positional data of the tracked object with the HMD sensors while the tracked object is in view of the HMD sensors. In this way, a change of position of the tracked object may be compared with the calculated position determined from the orientation data and offset collected from the tracked object. In this way the, the calculated position data can be normalized, and a correction factor can be applied to ensure accuracy of the offset over time and compatibility of the calculated or simulated translation values with the coordinate system of the HMD.

At block 612, the system is configured to augment the collected orientation data with the calculated rotational offset to generate translational positioning data for the tracked object. The present invention is configured to model and/or calculate translational positioning data for the controllers by adding a rotational offset value to the orientation data determined by the controllers. In this way, translational positioning data for the controllers can be derived even if the controllers are out of view of the HMD cameras or sensors (FIGS. 8A and 8B). What is more, by leveraging a transformation of the collected orientation data instead of relying on additional camera hardware, this software-based solution is not dependent on a field-of-view of a camera of the HMD and can provide and improved tracking range outside the boundaries the HMD sensors. In one embodiment, with incorporation of the calculated tracking data, the system has an effective field-of-view of at least 300°. In another embodiment, the effective field-of-view of the system utilizing the calculated tracking data is at least 340°.

In some embodiments, the system is configured to continually calculate the translational positioning data of the tracked object based on the collected orientation data in the background. In other embodiments, calculation of the translational positioning data from the collected orientation data may be automatically triggered when the tracked object leaves a field-of-view of the HMD sensors, wherein the tracked object can no longer be directly tracked with the HMD sensors. In one embodiment, when the system determines that the tracked object has left the field-of-view of the HMD sensors, the system is configured to hand-off tracking of the tracked object from the HMD to the simulated positional tracking described herein that is executed by the system (e.g., using a simulation algorithm or the like).

At block 614, the system is configured to render a new position of the tracked object in a virtual environment based on a calculated position data of the object. The tracked object is rendered by the system and displayed to a user via a display of the HMD, wherein the new position of the tracked object corresponds to an actual position of the tracked object relative to the user in the actual environment. The positional data used by the system to render the tracked object in the new position may include the calculated translational positioning data determined through application of the rotational offset derived from the collected orientation data of the user input device.

In a specific embodiment, the VR systems described herein are of particular use for safely simulating hazardous, real-world environments for the purpose of training and/or user evaluation. For example, as previously discussed, the VR system may be used to simulate an electric line working environment, wherein a user is required to complete a series of tasks (e.g. replacement of a transformer bank) as the user normally would in the field. In this specific example, a user may be required to operate a lift bucket within the simulation environment. Typically, in order to safely operate a lift bucket, a user is required to simultaneously operate a lift control interface (e.g., a button, handle, lever, or the like) while looking in a direction of travel of the bucket which is commonly in a direction facing away from the control interface. The solutions of the present invention are of particular use in this scenario, as this action would typically require that a user's hand and/or a held controller be positioned behind the user, wherein tracking of the controller through conventional methods could be obstructed or hindered. The positional tracking systems and methods described herein enable tracking of a controller even when the controller is out of a field-of-view of conventional AIO HMD devices. As such, the user may use the controller, and the VR systems as a whole, to realistically simulate operation of the lift controls while appropriately looking in a direction of travel. In this regard, FIGS. 8A and 8B depict a handheld controller 805 being rotated by a user. FIGS. 8A and 8B show the position of the controller 805 relative to a virtual environment 810 that includes a handle 815 that be used to operate a virtual lift bucket. My measuring the rotation of the controller 805, the approximate position of the controller 805 can be determined, thereby allowing the user to operate the handle 815 with the virtual environment. The solutions of the present invention may be used in conjunction with the virtual reality and training system as described in more detail in U.S. patent application Ser. No. 16/451,730, now published as U.S. Patent Application Pub. No. 2019/0392728, which is hereby incorporated by reference in its entirety.

In some embodiments, the VR systems described herein may be configured to accommodate multiple users using multiple VR devices (e.g., each user having an associated HMD) at the same time. The multiple users may, for example, be simultaneously trained through interaction with a virtual environment in real time. In one embodiment, the system may train and evaluate users in the same virtual environment, wherein the system is configured to provide cooperative user interaction with a shared virtual environment generated by the VR systems. The multiple users within the shared virtual environment may be able to view one another and each other's actions within the virtual environment. The VR systems may be configured to provide means for allowing communication between the multiple users (e.g., microphone headset or the like).

In a specific example, the VR systems may provide a shared virtual environment comprising a line working training simulation for two or more workers maintaining or repairing the same transformer bank or the like. The two workers may each be provided with separate locations (e.g., bucket locations) within the shared virtual environment or, alternatively, a shared space or location simulating an actual line working environment. In another specific example, only a first worker may be positioned at a bucket location, while a second worker is positioned in a separate location such as located on the ground below the bucket within the shared virtual environment. In another specific example, a first user may be positioned at a bucket location while a second user may be positioned as a qualified observer within the same virtual environment, for example, on the ground below the bucket within the shared virtual environment.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with virtual reality and, more specifically, virtual reality tracking.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A virtual reality system comprising:
a head-mounted display configured for rendering and displaying a virtual environment, the head-mounted display further comprising:
at least one sensor for tracking an object in a surrounding environment, the at least one sensor having a first field-of-view;
an auxiliary sensor system coupled to the head-mounted display, the auxiliary sensor system having a second field-of-view, wherein the first field-of-view and the second field-of-view overlap to form a combined field-of-view, and wherein the combined field-of-view is greater than the first field-of-view;
a processing device;
a memory device; and
computer-readable instructions stored in the memory, which when executed by the processing device cause the processing device to:
track a position of the object in the surrounding environment with the at least one sensor;
render the object in the virtual environment based on the position determined by the at least one sensor;
determine that the object has left the first field-of-view of the at least one sensor and entered the second field-of-view associated with the auxiliary sensor system;
in response to determining that the object has left the first field-of-view and entered the second field-of-view, track the position of the object in the surrounding environment with the auxiliary sensor system; and
render the object in the virtual environment based on the position determined by the auxiliary sensor system.

2. The virtual reality system of claim 1, wherein the combined field-of-view is at least 340°.

3. The virtual reality system of claim 1, wherein the first field-of-view is 200° or less.

4. The virtual reality system of claim 1 further comprising a user input device, wherein the object tracked by the at least one sensor and the auxiliary sensor system is the user input device.

5. The virtual reality system of claim 1, wherein tracking the positioning of the object in the surrounding environment with the auxiliary sensor system further comprises translating from a first coordinate system associated with the auxiliary sensor system to a second coordinate system associated with the head-mounted display.

6. A computer program product for improving a virtual reality system, the computer program product comprising at least one non-transitory computer-readable medium having computer-readable instructions embodied therein, the computer-readable instructions, when executed by a processing device, cause the processing device to perform the steps of:
tracking a position of an object in a surrounding environment with at least one sensor of a head-mounted display;
rendering the object in a virtual environment based on the position determined by the at least one sensor;
determining that the object has left a first field-of-view of the at least one sensor and entered a second field-of-view associated with an auxiliary sensor system coupled to the head-mounted display;
in response to determining that the object has left the first field-of-view and entered the second field-of-view, track the position of the object in the surrounding environment with the auxiliary sensor system; and
render the object in the virtual environment based on the position determined by the auxiliary sensor system.

7. The computer program product of claim 6, wherein the object tracked by the at least one sensor and the auxiliary sensor system is a user input device.

8. The computer program product of claim 6, wherein tracking the positioning of the object in the surrounding environment with the auxiliary sensor system further comprises translating from a first coordinate system associated with the auxiliary sensor system to a second coordinate system associated with the head-mounted display.

9. A virtual reality system comprising:
a user input device comprising an orientation sensor configured for collecting orientation data associated with the user input device; and
a head-mounted display in communication with the user input device, the head-mounted display being configured for rendering and displaying a virtual environment, the head-mounted display further comprising:
at least one sensor for tracking a position of the user input device, the at least one sensor having a field-of-view;
a processing device;
a memory device; and
computer-readable instructions stored in the memory, which when executed by the processing device cause the processing device to:
track the position of the user input device with the sensor;
render an object in the virtual environment based on the position of the user input device determined by the sensor;
determine that the user input device has left the field-of-view of the sensor;
in response to determining that the user input device has left the field-of-view of the sensor, determine a new position of the user input device based on the orientation data collected from the orientation sensor; and
render the object in the virtual environment based on the new position.

10. The virtual reality system of claim 9, wherein determining the new position of the user input device based on the orientation data further comprises transforming the orientation data to translational position data.

11. The virtual reality system of claim 10, wherein transforming the orientation data to translational position data further comprises deriving a rotational offset from the orientation data of the user input device.

12. The virtual reality system of claim 9, wherein determining the new position of the user input device further comprises determining a last known position of the user input device with the sensor before the user input device leaves the field-of-view, and wherein the new position is based at least partially on the last known position.

13. The virtual reality system of claim 9, wherein the orientation sensor is selected from a group consisting of an inertial measurement unit, an accelerometer, a gyroscope, and a motion sensor.

14. A computer program product for improving a virtual reality system, the computer program product comprising at least one non-transitory computer-readable medium having computer-readable instructions embodied therein, the computer-readable instructions, when executed by a processing device, cause the processing device to perform the steps of:
tracking a position of a user input device using a sensor of a head-mounted display, wherein the user input device comprises an orientation sensor;
rendering an object in a virtual environment based on the position of the user input device determined by the sensor;
determining that the user input device has left a field-of-view of the sensor;
in response to determining that the user input device has left the field-of-view of the sensor, determining a new position of the user input device based on orientation data collected from the orientation sensor; and
rendering the object in the virtual environment based on the new position.

15. The computer program product of claim 14, wherein determining that the user input device has left a field-of-view of the sensor further comprises transforming the orientation data to translational position data.

16. The computer program product of claim 15, wherein transforming the orientation data to translational position data further comprises deriving a rotational offset from the orientation data of the user input device.

17. The computer program product of claim 14, wherein determining the new position of the user input device further comprises determining a last known position of the user input device with the sensor before the user input device leaves the field-of-view, and wherein the new position is based at least partially on the last known position.

18. The computer program product of claim 14, wherein the orientation sensor is selected from a group consisting of an inertial measurement unit, an accelerometer, a gyroscope, and a motion sensor.
